(19) United States
(12) Patent Application Publication
(10) Pub. No.: US 2026/0081153 A1
(43) Pub. Date: Mar. 19, 2026

(54) POSITIVE ELECTRODE ACTIVE MATERIAL, ELECTRODE, AND BATTERY

(71) Applicant: TOYOTA JIDOSHA KABUSHIKI KAISHA, Toyota-shi (JP)

(72) Inventors: Yuki ISHIGAKI, Nisshin-shi (JP); Tatsuya EGUCHI, Kariya-shi (JP); Takeshi Kimijima, Kariya-shi (JP)

(73) Assignee: TOYOTA JIDOSHA KABUSHIKI KAISHA, Toyota-shi (JP)

(21) Appl. No.: 19/312,917

(22) Filed: Aug. 28, 2025

(30) Foreign Application Priority Data
Sep. 18, 2024 (JP) 2024-161039

(51) Int. Cl. H01M 4/58

(52) U.S. Cl. CPC H01M 4/5825

(57) ABSTRACT

A positive electrode active material comprises powder. The powder includes secondary particles. Each of the secondary particles includes primary particles. Each of the primary particles includes an olivine-type phosphate compound. In an SEM image of the powder, a proportion of the secondary particles each having an open pore is 40% or more. For the secondary particles each having an open pore, a relationship of “0.10≤d/D≤0.70” is satisfied. “d” represents a pore diameter of the open pore. “D” represents a maximum Feret diameter of the secondary particle.

### CROSS REFERENCE TO RELATED APPLICATIONS

This nonprovisional application is based on Japanese Patent Application No. 2024-161039 filed on Sep. 18, 2024, with the Japan Patent Office, the entire contents of which are hereby incorporated by reference.

### BACKGROUND

### Field

The present disclosure relates to a positive electrode active material, an electrode, and a battery.

### Description of the Background Art

International Patent Laying-Open No. WO 2021/153110 discloses granules of olivine-type positive electrode active material particles.

### SUMMARY

As a positive electrode active material, olivine-type phosphate compounds have been developed. Olivine-type phosphate compounds tend to have low electrical conductivity. Because of this, conventionally, attempts have been made to improve the electrical conductivity by reducing the size of primary particles constituting secondary particles (granules). However, there is still room for improvement in low-temperature properties.

An object of the present disclosure is to improve low-temperature properties.

Hereinafter, the technical configuration and effects of the present disclosure will be described. It should be noted that the action mechanism according to the present disclosure includes presumption. The action mechanism does not limit the technical scope of the present disclosure.
1. An aspect of the present disclosure is a positive electrode active material. The positive electrode active material comprises powder. The powder includes secondary particles. Each of the secondary particles includes primary particles. Each of the primary particles includes an olivine-type phosphate compound. In a scanning electron microscope (SEM) image of the powder, a proportion of the secondary particles each having an open pore is 40% or more. For the secondary particles each having an open pore, a relationship of “0.10≤d/D≤0.70” is satisfied. “d” represents a pore diameter of the open pore. “D” represents a maximum Feret diameter of the secondary particle.

The shape of the secondary particles (granules) can affect liquid retention properties for retaining electrolyte solution in the electrode. When the liquid retention properties are not sufficient, ion conduction around the positive electrode active material may be low. During discharging in a low-temperature environment (for example, in an environment at −10° C. or less), ions may not be supplied enough and thereby direct-current resistance (DCIR) may rise.

Conventionally, in an olivine-type phosphate compound secondary particle, primary particles of several dozen nanometers are present very close to each other. Because of this, electrolyte solution tends not to permeate into the secondary particle. In the present disclosure, granulation is carried out in such a manner that secondary particles each having an open pore (hereinafter also called “open-pore particles”) can be formed more frequently. More specifically, the proportion of open-pore particles in the powder is as high as 40% or more. Further, in the present disclosure, the open pore has a certain relative size to the size of the secondary particle. More specifically, the relationship of “0.10≤d/D≤0.70” is satisfied. When the proportion of open-pore particles is 40% or more and the relationship of “0.10≤d/D≤0.70” is satisfied, low-temperature properties are expected to be markedly enhanced. It may be because liquid retention properties of the powder (a group of secondary particles) are markedly enhanced.

Hereinafter, “the ratio of the pore diameter of the open pore to the maximum Feret diameter of the secondary particle” is also called the size ratio “d/D”.
2. The positive electrode active material according to “1” above may include the following configuration, for example. For the secondary particles each having an open pore, a relationship of “0.24≤d/D≤0.51” is satisfied.

When the size ratio “d/D” is from 0.24 to 0.51, low-temperature properties are expected to be enhanced even more.
3. The positive electrode active material according to “2” above may include the following configuration, for example. For the secondary particles each having an open pore, a relationship of “0.31≤d/D≤0.40” is satisfied.

When the size ratio “d/D” is from 0.31 to 0.40, low-temperature properties are expected to be enhanced even more.
4. The positive electrode active material according to any one of “1” to “3” above may include the following configuration, for example. The proportion of the secondary particles each having an open pore is 60% or more.

When the proportion of the open-pore particles is 60% or more, low-temperature properties are expected to be enhanced even more.
5. The positive electrode active material according to any one of “1” to “3” above may include the following configuration, for example. The proportion of the secondary particles each having an open pore is 80% or more.

When the proportion of the open-pore particles is 80% or more, low-temperature properties are expected to be enhanced even more.
6. The positive electrode active material according to any one of “1” to “5” above may include the following configuration, for example. A maximum Feret diameter of the primary particle is from 10 to 90 nm.
7. The positive electrode active material according to any one of “1” to “6” above may include the following configuration, for example. The olivine-type phosphate compound includes lithium manganese phosphate.

As an olivine-type phosphate compound, lithium iron phosphate (which may be abbreviated as “LFP” hereinafter) has been developed. However, due to its low discharge voltage, LFP has an issue in terms of energy density. As compared to LFP, lithium manganese phosphate (which may be abbreviated as “LMP” hereinafter) is expected to have high discharge voltage. When the positive electrode active material includes LMP, output properties are expected to be enhanced, for example.
8. An aspect of the present disclosure is an electrode. The electrode includes a positive electrode layer. The positive electrode layer includes the positive electrode active material according to any one of “1” to “7”.

The positive electrode layer may also be called “a positive electrode active material layer”, “a positive electrode composite material layer”, and the like. It should be noted that “electrode” may be either “a monopolar electrode (a positive electrode)” or “a bipolar electrode” as long as it includes a positive electrode layer.
9. An aspect of the present disclosure is a battery. The battery includes the electrode according to “8” above and an electrolyte solution.

The battery is expected to exhibit excellent low-temperature properties. It may be because liquid retention properties of the electrode (the positive electrode layer) are high.
10. The battery according to “9” above may include the following configuration, for example. The battery has a bipolar structure.

The bipolar structure may be formed by stacking bipolar electrodes together. With the bipolar structure, output properties are expected to be enhanced, for example.

In the following, an embodiment of the present disclosure (which may be simply called “the present embodiment” hereinafter) and an example of the present disclosure (which may be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual view illustrating a secondary particle according to the present embodiment.

FIG. 2 is a schematic flowchart illustrating a method of producing a positive electrode active material according to the present embodiment.

FIG. 3 is a schematic perspective view illustrating a battery according to the present embodiment.

FIG. 4 is a schematic view of a cross section cut along the line VI-VI in FIG. 3.

FIG. 5 is a temperature profile during calcination.

FIG. 6 is a table showing experiment results.

FIG. 7 is a graph showing experiment results.

### DESCRIPTION OF THE PREFERRED EMBODIMENTS

### Terms and Phrases

Expressions such as “comprise”, “include”, and “have”, and other similar terms are open-ended expressions. In the configuration expressed by an open-ended expression, in addition to an essential component, an additional component may or may not be further included. The expression “consist of” is a closed-end expression. However, even in a configuration that is expressed by a closed-end expression, impurities present under ordinary circumstances as well as an additional element irrelevant to the technique of interest may be included. The expression “consist essentially of” is a semiclosed-end expression. A configuration expressed by a semiclosed-end expression tolerates addition of an element that does not substantially affect the fundamental, novel features of the technique of interest.

Expressions such as “may” and “can” are not intended to mean “must” (obligation) but rather mean “there is a possibility” (tolerance).

Regarding a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

Expressions such as “first” and “second” are used solely for differentiating a plurality of elements from each other. Such expressions do not limit the scope of these elements. For example, these expressions are independent of the order and the significance of these elements.

Any geometric term should not be interpreted solely in its exact meaning. Examples of geometric terms include “parallel”, “vertical”, “orthogonal”, and the like. For example, as long as substantially the same or similar functions are obtained, the relative direction, angle, distance, and the like may vary. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A singular form may also include its plural meaning, unless otherwise specified. For example, a particle may mean a plurality of particles, a group of particles, and a powdery and granular material.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Each of “not less than” and “not more than” is represented by an inequality symbol with an equality symbol, e.g., “≤, ≥”. Each of “more than” and “less than” is represented by an inequality symbol without an equality symbol, e.g., “<, >”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean ±5%, ±3%, ±1%, and/or the like, for example. Each numerical value may be an approximate value that can vary depending on the implementation configuration of the technique of interest. Each numerical value may be expressed in significant figures. Unless otherwise specified, each measured value may be the average value obtained by multiple rounds of measurement. The number of rounds of measurement may be 3 or more, or may be 5 or more, or may be 10 or more. Generally, the greater the number of rounds of measurement is, the more reliable the average value is expected to be. Each measured value may be rounded off based on the number of the significant figures. Each measured value may include an error occurring due to the identification limit of the measurement apparatus, for example.

An apparatus and/or the like used for measurement of various values is merely an example. It is possible to use a product similar to the apparatus and/or the like presented as an example. When a similar product is used, the measurement conditions may be adjusted to be suitable for the apparatus.

“Proportion of open-pore particles” is measured by the procedure described below. Powder (positive electrode active material) is sprinkled onto the surface of a piece of carbon tape. The powder on the carbon tape is examined with an SEM, and thereby a surface SEM image of the powder is obtained. The magnification for the examination is adjusted in such a way that 30 or more secondary particles are contained in the field of view. The magnification for the examination may be adjusted within the range of 5000 to 15000 times, for example. The magnification may be about 10000 times, for example. In a plurality of fields of view (for example, in about 5 fields of view), a total of 30 secondary particles are selected. For example, a total of 30 secondary particles each having a maximum Feret diameter of 5 μm or more may be randomly selected. Among the selected 30 secondary particles, open-pore particles are counted. By the following equation, the proportion of the open-pore particles is determined.

(Proportion of open-pore particles)=N1/(N1+N2)
N1: Number of open-pore particles
N2: Number of non-open-pore particles

The relationship of “N1+N2=30” is satisfied.

The “maximum Feret diameter” of a particle refers to the length of the long side of a circumscribing rectangular (an oblong or a square) that circumscribes the particle. When the circumscribing rectangular is square, the length of the long side refers to the length of a side. The “pore diameter” of an open pore refers to the maximum Feret diameter of the opening of the open pore. The maximum Feret diameter of a primary particle may be measured in a transmission electron microscopy (TEM) image, for example.

“Open pore” refers to a pore that is open to the outside of the secondary particle. In an SEM image of a secondary particle, an open pore (an opening) looks relatively dark. For example, an open pore (an opening) may be identified by image processing. For example, the SEM image may be evaluated in 8-bit gray scale. For example, image processing software “Image J” and/or the like may be used. Within one secondary particle, the highest luminance is identified. A closed region in the secondary particle with a luminance of 50% or less relative to the highest luminance may be regarded as an open pore (an opening). The luminance of an open pore relative to the highest luminance may be 40% or less, or 30% or less, or 20% or less, or 10% or less, for example.

The size ratio “d/D” is the ratio of the pore diameter (d) of an open pore to the maximum Feret diameter “D” of the secondary particle. The size ratio “d/D” is measured by the procedure described below. For each of the open-pore particles (30 secondary particles) identified in the above-mentioned SEM image, the size ratio “d/D” is measured. The arithmetic mean of the plurality of size ratios “d/D” is regarded as the size ratio “d/D” of the measurement target (powder).

“D50” refers to a particle size in volume-based particle size distribution (cumulative distribution) at which the cumulative value reaches 50%. The volume-based particle size distribution is measured with a laser-diffraction particle size distribution analyzer.

The chemical composition of a compound may be measured by inductively coupled plasma atomic emission spectroscopy (ICP-AES). For example, a sample (for example, a positive electrode active material) in an amount of 0.1 g is dissolved in a mixed acid (10 ml) of hydrochloric acid and sulfuric acid to prepare a sample solution. The sample solution is diluted to a proper concentration with the use of a volumetric flask. After dilution, composition analysis is carried out with an ICP-AES apparatus. For example, a product under the trade name “PS3520 UVDD II (manufactured by Hitachi High-Tech Science)” and/or the like may be used.

“Derivative” refers to a compound that is derived from its original compound by at least one partial modification selected from the group consisting of functional group introduction, atom replacement, oxidation, reduction, and other chemical reactions. The position of modification may be one position, or may be a plurality of positions. “Substituent” may include at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like, for example. These substituents may be further substituted. When there are two or more substituents, these substituents may be the same as one another or may be different from each other. A plurality of substituents may be bonded together to form a ring.

### —Positive Electrode Active Material—

A positive electrode active material comprises powder. The D50 of the powder may be 1 μm or more, or 3 μm or more, or 5 μm or more, or 10 μm or more, or 15 μm or more, or 20 μm or more, for example. The D50 may be 30 μm or less, or 25 μm or less, or 20 μm or less, or 15 μm or less, or 10 μm or less, for example.

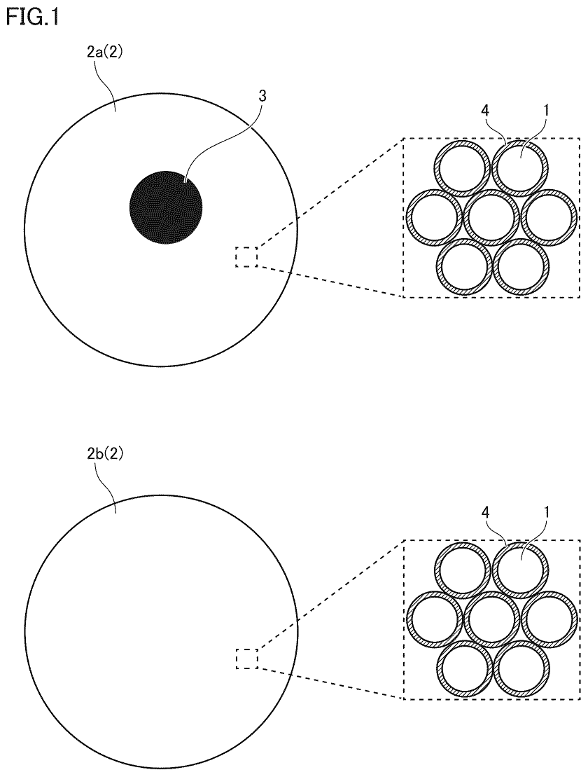

FIG. 1 is a conceptual view illustrating a secondary particle according to the present embodiment. The powder includes secondary particles. The secondary particles include open-pore particles 2a. Open-pore particle 2a is a secondary particle having an open pore 3. In addition to open-pore particles 2a, the secondary particles may also include non-open-pore particles 2b. Non-open-pore particle 2b is a secondary particle that does not have open pore 3. Although non-open-pore particle 2b may have open pore 3 at a position that is invisible in an SEM image, determination of the presence or absence of open pore 3 is based on the appearance in an SEM image.

In the powder, the proportion of open-pore particles 2a is 40% or more. For example, the proportion of open-pore particles 2a may be 50% or more, or 60% or more, or 70% or more, or 80% or more, or 90% or more. For example, when the proportion of open-pore particles 2a is 60% or more, low-temperature properties are expected to be enhanced even more. For example, when the proportion of open-pore particles 2a is 80% or more, low-temperature properties are expected to be enhanced even more. For example, the proportion of open-pore particles 2a may be 100% or less, or 90% or less. For example, when the proportion of open-pore particles 2a is from 40 to 80%, low-temperature properties and energy density are expected to be well balanced.

In the powder, for open-pore particles 2a, the relationship of “0.10≤d/D≤0.70” is satisfied. The size ratio “d/D” may be 0.11 or more, or 0.12 or more, or 0.15 or more, or 0.20 or more, or 0.24 or more, or 0.26 or more, or 0.30 or more, or 0.31 or more, or 0.32 or more, or 0.35 or more, or 0.39 or more, or 0.40 or more, or 0.45 or more, or 0.47 or more, or 0.49 or more, or 0.50 or more, or 0.51 or more, or 0.55 or more, or 0.60 or more, or 0.65 or more, or 0.68 or more, or 0.69 or more, for example. The size ratio “d/D” may be 0.69 or less, or 0.68 or less, or 0.65 or less, or 0.60 or less, or 0.55 or less, or 0.51 or less, or 0.50 or less, or 0.49 or less, or 0.47 or less, or 0.45 or less, or 0.40 or less, or 0.39 or less, or 0.35 or less, or 0.32 or less, or 0.31 or less, or 0.30 or less, or 0.26 or less, or 0.24 or less, or 0.20 or less, or 0.15 or less, or 0.12 or less, or 0.11 or less, for example. In other words, the relationship of “0.24≤d/D≤0.51” may be satisfied, for example. The relationship of “0.31≤d/D≤0.40” may be satisfied, for example. When these relationships are satisfied, low-temperature properties are expected to be further enhanced.

Secondary particle 2 may have any outer shape. Secondary particle 2 may have a spherical outer shape. When secondary particle 2 is spherical, packing properties and the like are expected to be enhanced, for example. Furthermore, when open-pore particle 2a is spherical, for example, it is expected that open pore 3 tends not to be crushed at the time when the electrode is pressed. The sphericity of secondary particle 2 may be 0.85 or more, or 0.90 or more, or 0.95 or more. The sphericity of secondary particle 2 may be 1 or less, or 0.95 or less, or 0.90 or less, for example. “Sphericity” refers to the circularity in an SEM image (a two-dimensional image). The sphericity (circularity) is determined by the following equation.

$$ψ = 4 π S / {L}^{2}$$

ψ: Sphericity (circularity)
π: Circular constant
S: Cross-sectional area of secondary particle 2 (the area of a region surrounded by the contour of secondary particle 2)
L: Perimeter of secondary particle 2 (the length of the contour of secondary particle 2)

The sphericity refers to the arithmetic mean of 30 secondary particles 2. The sphericity of 30 secondary particles 2 is measured regardless of the presence or absence of open pore 3.

The arithmetic mean maximum Feret diameter of secondary particles 2 may be 3 μm or more, or 4 μm or more, or 5 μm or more, or 6 μm or more, or 7 μm or more, or 8 μm or more, or 9 μm or more, for example. The arithmetic mean maximum Feret diameter of secondary particles 2 may be 20 μm or less, or 15 μm or less, or 14 μm or less, or 13 μm or less, or 12 μm or less, or 11 μm or less, or 10 μm or less, or 9 μm or less, for example.

Each of open-pore particle 2a and non-open-pore particle 2b is a group of primary particles 1. In other words, each of open-pore particle 2a and non-open-pore particle 2b includes a plurality of primary particles 1. The maximum Feret diameter of primary particle 1 may be from 10 to 90 nm, for example. The maximum Feret diameter of primary particle 1 may be 20 nm or more, or 30 nm or more, or 40 nm or more, or 50 nm or more, or 60 nm or more, or 70 nm or more, or 80 nm or more, for example. The maximum Feret diameter of primary particle 1 may be 80 nm or less, or 60 nm or less, for example. The arithmetic mean of a plurality of primary particles 1 (for example, 30 of them) may be adopted as a representative value, for example.

To at least part of the surface of primary particle 1, carbon may be adhered. Carbon may be adhered to part of the surface of primary particle 1, or may be adhered to the entire surface of primary particle 1. The carbon may form a carbon layer 4. The amount of adhered carbon in mass fraction relative to secondary particle 2 may be 0.1% or more, or 0.5% or more, or 1% or more, or 2% or more, or 3% or more, or 4% or more, for example. The amount of adhered carbon in mass fraction relative to secondary particle 2 may be 5% or less, or 4% or less, or 3% or less, for example.

Each of primary particles 1 includes an olivine-type phosphate compound. “Olivine-type” refers to a crystal structure belonging to the space group Pnma. The space group is identified by X-ray diffraction (XRD) measurement of the powder. Primary particle 1 may be a single-phase compound, for example. As long as it includes an olivine-type crystalline phase, primary particle 1 may further include a phase that belongs to another space group. Primary particle 1 may further include an amorphous phase and/or the like, for example.

The olivine-type phosphate compound may include lithium iron phosphate (LFP), lithium manganese phosphate (LMP), and/or the like, for example. In LMP, part of manganese (Mn) may be replaced by iron (Fe). Fe-replaced LMP is also called lithium manganese iron phosphate (LMFP). LMP may have a composition represented by the following general formula, for example.

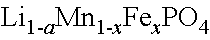

For example, the relationship of −0.5≤a≤0.5 may be satisfied. The Fe-replacing amount (x) may be 0 or more, or 0.05 or more, or 0.1 or more, or 0.2 or more, or 0.3 or more, or 0.4 or more, or 0.5 or more, or 0.6 or more, or 0.7 or more, or 0.8 or more, or 0.9 or more, for example. The Fe-replacing amount (x) may be 0.9 or less, or 0.8 or less, or 0.7 or less, or 0.6 or less, or 0.5 or less, or 0.4 or less, or 0.3 or less, or 0.2 or less, or 0.1 or less, for example.

The LMP may be doped with an element (a dopant) other than lithium (Li), Mn, Fe, phosphorus (P), and oxygen (O). The doping amount (the fraction in amount of substance relative to the amount of substance of Li) may be from 0.01 to 0.1, for example. The dopant may include at least one selected from the group consisting of boron (B), nitrogen (N), a halogen, silicon (Si), sodium (Na), magnesium (Mg), aluminum (Al), chromium (Cr), scandium (Sc), titanium (Ti), vanadium (V), cobalt (Co), nickel (Ni), copper (Cu), zinc (Zn), gallium (Ga), germanium (Ge), selenium (Se), strontium (Sr), yttrium (Y), zirconium (Zr), niobium (Nb), molybdenum (Mo), indium (In), lead (Pb), bismuth (Bi), antimony (Sb), tin (Sn), tungsten (W), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and an actinoid, for example.

The positive electrode active material may further include another component as long as it includes an olivine-type phosphate compound. This another component may include lithium-nickel composite oxide (LNO), lithium-cobalt composite oxide (LCO), lithium-manganese composite oxide (LMO), and/or the like, for example. The mixing ratio (in mass) between the olivine-type phosphate compound and the another component may be “(olivine-type phosphate compound)/(another component)=9/1 to 1/9”, or “(olivine-type phosphate compound)/(another component)=8/2 to 2/8”, or “(olivine-type phosphate compound)/(another component)=7/3 to 3/7”, or “(olivine-type phosphate compound)/(another component)=6/4 to 4/6”, for example. The positive electrode active material may be a mixture of powder of the olivine-type phosphate compound and powder of the another component, for example.

The LNO may have a crystal structure belonging to the space group R-3m, for example. The LNO may have a composition represented by the following general formula, for example.

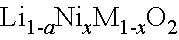

In the formula, the relationships of −0.5≤a≤0.5, 0≤x≤1 are satisfied. M may include, for example, at least one selected from the group consisting of Co, Mn, and Al. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1 may be satisfied. For example, the relationship of −0.4≤a≤0.4, −0.3≤a≤0.3, −0.2≤a≤0.2, or −0.1≤a≤0.1 may be satisfied.

The LNO may include at least one selected from the group consisting of LiNi_{0.9}Co_{0.1}O₂, LiNi_{0.9}Mn_{0.1}O₂, and LiNiO₂, for example.

The LNO may be represented by the following general formula, for example. A compound represented by the following general formula may also be called “NCM”.

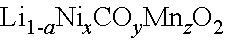

In the formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCM may include at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂, for example.

The LNO may be represented by the following general formula, for example. A compound represented by the following general formula may also be called “NCA”.

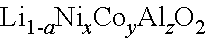

In the formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCA may include at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂, for example.

### —Method of Producing Positive Electrode Active Material—

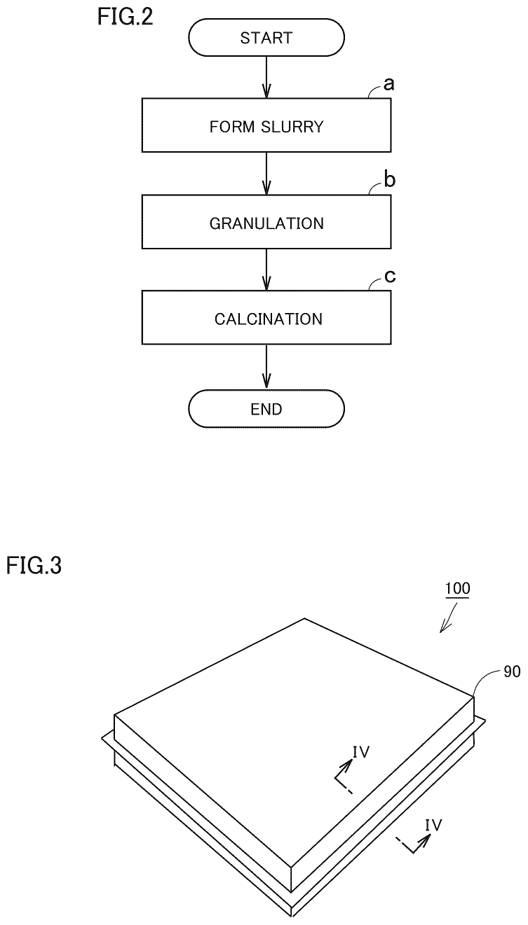

FIG. 2 is a schematic flowchart illustrating a method of producing a positive electrode active material according to the present embodiment. Hereinafter, “the method of producing a positive electrode active material according to the present embodiment” may be simply called “the present method”. The present method may comprise “(a) forming a slurry”, “(b) granulation”, “(c) calcination”, and the like, for example.

### (a) Forming Slurry

The present method may include forming a slurry by mixing a lithium compound, a manganese compound, a phosphate compound, and a solvent. When the final product to produce is LMFP, an iron compound is added to the raw material mixture. For example, the lithium compound, the manganese compound, the phosphate compound, and the iron compound may be prepared in amounts that satisfy the composition ratio (in amount of substance) specified in the composition formula “Li₁₋ₐMn₁₋ₓFeₓPO₄ (−0.5≤a≤0.5, 0≤x<1)”. The lithium compound may include lithium hydroxide and/or the like, for example. The manganese compound may include manganese carbonate and/or the like, for example. The phosphate compound may include lithium dihydrogen phosphate and/or the like, for example. The iron compound may include ferric phosphate and/or the like, for example.

When it is intended to make carbon adhered to the surface of each primary particle, a carbon source is added to the raw material mixture. The carbon source may include a sugar, an organic acid, and/or the like, for example. The carbon source may include glucose, sucrose, fructose, citric acid, and/or the like, for example. The amount of the carbon source to be added in mass fraction relative to the raw material mixture may be from 1 to 20%, for example.

The solvent may include water and/or the like, for example. The solid concentration of the slurry in mass fraction may be from 20 to 40%, for example.

Wet grinding may be carried out to adjust the particle size in the slurry. For example, wet grinding may be carried out to achieve a D50 from 0.10 to 1 μm.

### (b) Granulation

The present method may include granulation, namely drying the slurry to produce secondary particles (precursors). For example, spray drying may be carried out for granulation to produce secondary particles. Secondary particles formed by granulation operation are also called “granules”. That is, the secondary particles may also be called granules.

The frequency of open-pore particles to be formed (namely, the proportion of open-pore particles) tends to change depending on the temperature of the slurry at the time of spray drying. It is expected that enhancing dispersibility of the slurry can affect formation of open pores. Because of this, the slurry temperature may be adjusted to adjust the proportion of open-pore particles, for example. The slurry temperature may be adjusted before spray drying, for example. The slurry temperature may be adjusted to the range of 40 to 60° C., or to the range of 50 to 60° C., for example.

In addition to the adjustment of the slurry temperature, adding a dispersant to the slurry tends to change the pore diameter of the open pore. For example, when the solvent of the slurry contains water, a dispersant for aqueous slurry may be used. For example, a product under the trade name “DISPERBYK-199”, a product under the trade name “DISPERBYK-2015” (both are manufactured by BYK), and/or the like may be used. The amount of the dispersant to be added in mass fraction may be, for example, from 0.3 to 1% relative to the mass of the slurry.

The size (the maximum Feret diameter) of the secondary particles tends to change depending on, for example, the gas-liquid ratio of the atomization gas and the slurry at the time of spray drying. For example, the greater the nozzle pressure is, the smaller the secondary particles tend to be. For example, different combinations of “the nozzle pressure”, “the slurry temperature”, “the amount of the dispersant to be added”, and the like may be adopted to adjust the size ratio “d/D”.

### (c) Calcination

The present method may include performing heat treatment of the secondary particles (precursors) to produce an olivine-type phosphate compound. Any heat treatment furnace (such as, for example, an electric furnace, a muffle furnace, and/or the like) may be used. The heat treatment atmosphere may be a nitrogen atmosphere, for example. The heat treatment temperature may be from 400 to 700° C., for example. The heat treatment time may be from 4 to 6 hours, for example.

### —Battery—

In some present embodiments, the battery has a monopolar structure. In some present embodiments, the battery has a bipolar structure. As an example, a battery having a bipolar structure (a bipolar battery) will be described.

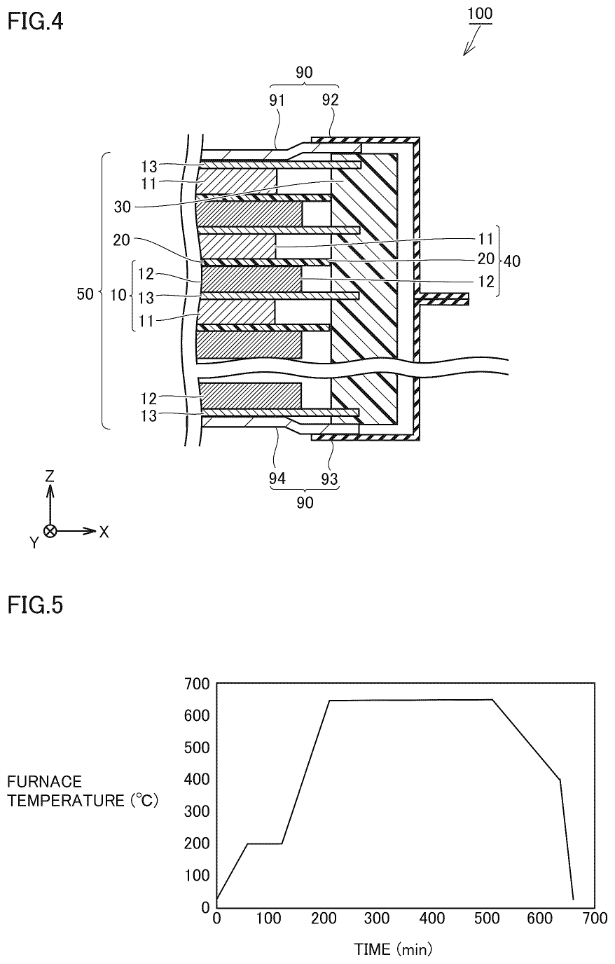

FIG. 3 is a schematic perspective view illustrating a battery according to the present embodiment. FIG. 4 is a schematic view of a cross section cut along the line VI-VI in FIG. 3. Hereinafter, “perpendicular-to-plane direction” refers to the direction of a normal to the surface of a sheet-form member (such as a foil sheet or an electrode, for example). “In-plane direction” refers to any direction that is orthogonal to the perpendicular-to-plane direction. In FIG. 4, the Z-axis direction corresponds to the perpendicular-to-plane direction. Each of the X-axis direction and the Y-axis direction is an example of an in-plane direction.

A battery 100 includes an exterior package 90 and a power generation element 50. Exterior package 90 accommodates power generation element 50. Exterior package 90 may include a first current collector plate 91, a first laminated film 92, a second laminated film 93, and a second current collector plate 94, for example. First laminated film 92 and second laminated film 93 are joined to each other at an end in an in-plane direction. At the joint portion between first laminated film 92 and second laminated film 93, a sealing material (not illustrated) may be interposed between first laminated film 92 and second laminated film 93.

At the ends in the stacking direction (the Z-axis direction), first current collector plate 91 and second current collector plate 94 are joined to power generation element 50, respectively. First laminated film 92 is joined to first current collector plate 91. Second laminated film 93 is joined to second current collector plate 94. At the joint portion between the current collector plate and the laminated film, a sealing material (not illustrated) may be interposed between the current collector plate and the laminated film.

Power generation element 50 includes a plurality of bipolar electrodes 10. Bipolar electrodes 10 are stacked in the perpendicular-to-plane direction (the Z-axis direction). In the perpendicular-to-plane direction, each bipolar electrode 10 includes a positive electrode layer 11, a current-collecting foil sheet 13, and a negative electrode layer 12 in this order. In an in-plane direction (for example, the X-axis direction), current-collecting foil sheet 13 extends outwardly beyond positive electrode layer 11 and negative electrode layer 12. For example, current-collecting foil sheet 13 may extend outwardly beyond positive electrode layer 11 and negative electrode layer 12 for the entire periphery in an in-plane direction.

Current-collecting foil sheet 13 is a conductor. For example, current-collecting foil sheet 13 may include a metal foil sheet, an electrically-conductive resin layer, and/or the like. For example, current-collecting foil sheet 13 may be formed by bonding an Al foil sheet and a Cu foil sheet together. A surface of current-collecting foil sheet 13 may have a carbon material applied thereto. The carbon material may include carbon black and/or the like, for example.

Power generation element 50 includes a sealing material 30. At an end in an in-plane direction, sealing material 30 is attached to current-collecting foil sheet 13. For example, sealing material 30 may be heat-sealed to current-collecting foil sheet 13. For example, sealing material 30 may be provided along the entire periphery in an in-plane direction. Sealing material 30 may include a resin material and/or the like, for example. Sealing material 30 seals interstices between current-collecting foil sheets 13 that are adjacent to each other in the perpendicular-to-plane direction. The interstices between current-collecting foil sheets 13 are thus sealed with sealing material 30, and thereby cells 40 are formed. A cell 40 is the smallest constituent unit of power generation element 50. Because it includes a plurality of cells 40, battery 100 may also be referred to as “a bipolar module”. Each of cells 40 is hermetically sealed. Cells 40 are segregated from each other. Each of cells 40 includes positive electrode layer 11, a separator 20, negative electrode layer 12, and an electrolyte solution.

### Positive Electrode Layer

Positive electrode layer 11 is adhered to one side of current-collecting foil sheet 13. For example, a groove may be formed in positive electrode layer 11. Positive electrode layer 11 may be formed in stripes, for example. Positive electrode layer 11 includes a positive electrode active material. The details of the positive electrode active material are as described above. The thickness of positive electrode layer 11 may be 10 μm or more, or 100 μm or more, or 200 μm or more, or 400 μm or more, or 600 μm or more, or 800 μm or more, or 1 mm or more, for example. The thickness of positive electrode layer 11 may be 1.2 mm or less, or 1 mm or less, or 800 μm or less, for example. At a thickness of 200 μm or more, for example, the influence of the liquid retention properties of the positive electrode active material may be markedly exhibited. In a bipolar structure, positive electrode layer 11 as thick as 200 μm or more may be desirable.

In addition to the positive electrode active material, positive electrode layer 11 may further include a conductive material, a binder, and the like, for example. The amount of the conductive material to be used may be, for example, from 0.1 to 10 parts by mass relative to 100 parts by mass of the positive electrode active material. The conductive material may include any component. The conductive material may include at least one selected from the group consisting of graphite, acetylene black (AB), Ketjenblack (registered trademark), vapor grown carbon fibers (VGCFs), carbon nanotubes (CNTs), and graphene flakes (GFs), for example.

The amount of the binder to be used may be, for example, from 0.1 to 10 parts by mass relative to 100 parts by mass of the positive electrode active material. The binder may include any component. The binder may include at least one selected from the group consisting of polyvinylidene difluoride (PVdF), vinylidene difluoride-hexafluoropropylene copolymer (PVdF-HFP), polytetrafluoroethylene (PTFE), carboxymethylcellulose (CMC), polyacrylic acid (PAA), polyvinyl alcohol (PVA), polyvinylpyrrolidone (PVP), polyoxyethylene alkyl ether, and derivatives of these, for example.

Positive electrode layer 11 may further include an inorganic filler, an organic filler, a solid electrolyte, a surface modifier, a dispersant, a lubricant, a flame retardant, a protective agent, a flux, a coupling agent, an adsorbent, and/or the like, for example. The positive electrode active material layer may include polyoxyethylene allylphenyl ether phosphate, zeolite, silane coupling agent, MoS₂, WO₃, and/or the like, for example.

### Negative Electrode Layer

Negative electrode layer 12 is adhered to one side of current-collecting foil sheet 13. Negative electrode layer 12 is positioned on the opposite side to the side on which positive electrode layer 11 is positioned. The area of negative electrode layer 12 may be greater than that of positive electrode layer 11. Negative electrode layer 12 includes a negative electrode active material.

The negative electrode active material may be in particle form, or may be in sheet form, for example. The D50 of the negative electrode active material may be 1 μm or more, or 5 μm or more, or 10 μm or more, for example. The D50 of the negative electrode active material may be 30 μm or less, or 20 μm or less, or 15 μm or less, or 10 μm or less, for example.

The negative electrode active material may include any component. The negative electrode active material may include at least one selected from the group consisting of carbon-based active material, alloy-based active material, Si—C composite material, Li metal, Li-based alloy, and lithium titanate, for example. In some present embodiments, the battery may be a Li-metal negative electrode battery.

The carbon-based active material may include at least one selected from the group consisting of graphite, soft carbon, and hard carbon, for example. The “graphite” collectively refers to natural graphite and artificial graphite. The graphite may be a mixture of natural graphite and artificial graphite. The mixing ratio (mass ratio) may be “(natural graphite)/(artificial graphite)=1/9 to 9/1”, or “(natural graphite)/(artificial graphite)=2/8 to 8/2”, or “(natural graphite)/(artificial graphite)=3/7 to 7/3”, for example.

The surface of the graphite may be covered with amorphous carbon, for example. The surface of the graphite may be covered with another type of material, for example. This another type of material may include at least one selected from the group consisting of P, W, Al, and O, for example. The another type of material may include at least one selected from the group consisting of Al(OH)₃, AlOOH, Al₂O₃, WO₃, Li₂CO₃, LiHCO₃, and Li₃PO₄, for example.

The alloy-based active material may include at least one selected from the group consisting of Si, Li silicate, SiO, Si-based alloy, tin (Sn), SnO, and Sn-based alloy, for example.

SiO may be represented by the following general formula, for example.

### SiOₓ

In the formula, the relationship of 0<x<2 is satisfied. For example, the relationship of 0.5≤x≤1.5 or 0.8≤x≤1.2 may be satisfied.

“Si—C composite material” refers to a composite material composed of a carbon-based active material (such as graphite) and an alloy-based active material (such as Si). For example, Si microparticles may be dispersed inside carbon particles. For example, Si microparticles may be dispersed inside graphite particles. For example, Li silicate particles may be covered with a carbon material (such as amorphous carbon).

### Separator

Separator 20 is capable of separating positive electrode layer 11 from negative electrode layer 12. Separator 20 is electrically insulating. Separator 20 may include at least one selected from the group consisting of a resin film (a polymer film), an inorganic particle layer, and an organic particle layer, for example. Separator 20 may include a resin film and an inorganic particle layer, for example.

The resin film is porous. The resin film may include a microporous film, a nonwoven fabric, and/or the like, for example. The resin film includes a resin skeleton. The resin skeleton may be continuous in mesh form, for example. Gaps in the resin skeleton form pores. The resin film allows an electrolyte solution to permeate therethrough. The resin film may have an average pore size of 1 μm or less, for example. The resin film may have an average pore size from 0.01 to 1 μm, or from 0.1 to 0.5 μm, for example. “Average pore size” may be measured by mercury porosimetry. The resin film may have a Gurley value from 50 to 250 s/100 cm³, for example. “Gurley value” may be measured by a Gurley test method.

The resin film may include at least one selected from the group consisting of an olefin-based resin, a polyurethane-based resin, a polyamide-based resin, a cellulose-based resin, a polyether-based resin, an acrylic-based resin, a polyester-based resin, and the like, for example. The resin film may include at least one selected from the group consisting of polyethylene (PE), polypropylene (PP), polyamide (PA), polyamide-imide (PAI), polyimide (PI), aromatic polyamide (aramid), polyphenylene ether (PPE), and derivatives of these, for example. The resin film may be formed by stretching, phase separation, and/or the like, for example. The resin film may have a thickness from 5 to 50 μm, or from 10 to 25 μm, for example.

The resin film may have a monolayer structure. The resin film may be made of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

The inorganic particle layer may be formed on the surface of the resin film. The inorganic particle layer may be formed on only one side of the resin film, or may be formed on both sides of the resin film. The inorganic particle layer may be formed on the side facing the positive electrode layer 11, or may be formed on the side facing the negative electrode layer 12. The inorganic particle layer may be formed on the surface of positive electrode layer 11, or may be formed on the surface of negative electrode layer 12.

The inorganic particle layer is porous. The inorganic particle layer includes inorganic particles. The inorganic particles may also be called “an inorganic filler”. Gaps between the inorganic particles form pores. The inorganic particle layer may have a thickness from 0.5 to 10 μm, or from 1 to 5 μm, for example. The inorganic particles may include a heat-resistant material, for example. The inorganic particle layer that includes a heat-resistant material is also called “HRL (Heat Resistance Layer)”. The inorganic particles may include at least one selected from the group consisting of boehmite, alumina, zirconia, titania, magnesia, silica, and the like. The inorganic particles may have any shape. The inorganic particles may be spherical, rod-like, plate-like, fibrous, and/or the like, for example. The inorganic particles may have a D50 from 0.1 to 10 μm, or from 0.5 to 3 μm, for example. The inorganic particle layer may further include a binder. The binder may include at least one selected from the group consisting of an acrylic-based resin, a polyamide-based resin, a fluorine-based resin, an aromatic-polyether-based resin, and a liquid-crystal-polyester-based resin, and the like, for example.

Separator 20 may include an organic particle layer, for example. Separator 20 may include an organic particle layer instead of the resin film, for example. Separator 20 may include an organic particle layer instead of the inorganic particle layer, for example. Separator 20 may include both the resin film and an organic particle layer. Separator 20 may include both the inorganic particle layer and an organic particle layer. Separator 20 may include the resin film, the inorganic particle layer, and an organic particle layer.

The organic particle layer may have a thickness from 0.1 to 50 μm, or from 0.5 to 20 μm, or from 0.5 to 10 μm, or from 1 to 5 μm, for example. The organic particle layer includes organic particles. The organic particles may also be called “an organic filler”. The organic particles may include a heat-resistant material. The organic particles may include at least one selected from the group consisting of PE, PP, PTFE, PI, PAI, PA, aramid, and the like, for example. The organic particles may be spherical, rod-like, plate-like, fibrous, and/or the like, for example. The organic particles may have a D50 from 0.1 to 10 μm, or from 0.5 to 3 μm, for example.

Separator 20 may include a mixed layer, for example. The mixed layer includes both inorganic particles and organic particles.

### Electrolyte Solution

The electrolyte solution is a liquid electrolyte. The electrolyte solution includes a solute and a solvent. The concentration of the solute may be from 0.5 to 1 mol/L, or from 1 to 1.5 mol/L, or from 1.5 to 2 mol/L, or from 2 to 2.5 mol/L, or from 2.5 to 3 mol/L, for example. “Mol/L” may also be expressed as “M”. The solute includes a supporting salt (a Li salt). The solute may include an inorganic acid salt, an imide salt, an oxalato complex, a halide, and/or the like, for example. The solute may include at least one selected from the group consisting of LiPF₆, LiBF₄, LiClO₄, LiAsF₆, LiSbF₆, LiN(SO₂F)₂ “LiFSI”, LiN(SO₂CF₃)₂ “LiTFSI”, LiB(C₂O₄)₂ “LiBOB”, LiBF₂(C₂O₄) “LiDFOB”, LiPF₂(C₂O₄)₂ “LIDFOP”, LiPO₂F₂, FSO₃Li, LiI, LiBr, and derivatives of these, for example.

The electrolyte solution may include a carbonate-based solvent (a carbonate-ester-based solvent), for example. The solvent may include a cyclic carbonate, a chain carbonate, a fluorinated carbonate, and/or the like, for example. The solvent may include at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these, for example.

The solvent may include a cyclic carbonate (such as EC, PC, FEC) and a chain carbonate (such as EMC, DMC, DEC). The mixing ratio between the cyclic carbonate and the chain carbonate (volume ratio) may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio between the cyclic carbonate and the fluorinated cyclic carbonate (volume ratio) may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation, for example.

$${V}_{EC} + {V}_{FBC} + {V}_{EMC} + {V}_{DMC} + {V}_{DEC} = 10$$

In the above equation, each of V_{EC}, V_{FEC}, V_{EMC}, V_{DMC}, and V_{DEC} represents the volume ratio of EC, FEC, EMC, DMC, and DEC, respectively.

The relationships of 1≤V_{EC}≤4, 0≤V_{FEC}≤3, V_{EC}+V_{FEC}≤4, 0≤V_{EMC}≤9, 0≤V_{DMC}≤9, 0≤V_{DEC}≤9, 6≤V_{EMC}+V_{DMC}+V_{DEC}≤9 are satisfied.

For example, the relationship of 1≤V_{EC}≤2 or 2≤V_{EC}≤3 may be satisfied.

For example, the relationship of 1≤V_{FEC}≤2 or 2≤V_{FEC}≤4 may be satisfied.

For example, the relationship of 3≤V_{EMC}≤4 or 6≤V_{EMC}≤8 may be satisfied.

For example, the relationship of 3≤V_{DMC}≤4 or 6≤V_{DMC}≤8 may be satisfied.

For example, the relationship of 3≤V_{DEC}≤4 or 6≤V_{DEC}≤8 may be satisfied.

The solvent may have a composition of “EC/EMC=3/7”, “EC/DMC=3/7”, “EC/FEC/DEC=1/2/7”, “EC/DMC/EMC=3/4/3”, “EC/DMC/EMC=3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC-1/2/3/4” (volume ratio), and/or the like, for example.

The electrolyte solution may include an ether-based solvent. The electrolyte solution may include at least one selected from the group consisting of tetrahydrofuran (THF), 1,4-dioxane (DOX), 1,3-dioxolane (DOL), 1,2-dimethoxyethane (DME), 1,2-diethoxyethane (DEE), hydrofluoroether (HFE), ethylglyme, triglyme, tetraglyme, and derivatives of these, for example.

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include at least one selected from the group consisting of vinylene carbonate (VC), vinylethylene carbonate (VEC), 1,3-propane sultone (PS), tert-amylbenzene, 1,4-di-tert-butylbenzene, biphenyl (BP), cyclohexylbenzene (CHB), ethylene sulfite (ES), propane sultone (PS), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these, for example.

The components described above as the solute and the solvent may be used as a trace component (an additive). The additive may include at least one selected from the group consisting of LiBF₄, LiFSI, LiTFSI, LiBOB, LIDFOB, LIDFOP, LiPO₂F₂, FSO₃Li, LiI, LiBr, HFE, DOX, PC, FEC, and derivatives of these, for example.

The electrolyte solution may include an ionic liquid. The ionic liquid may include at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these, for example.

In some present embodiments, the battery may include a gelled electrolyte. In other words, the battery may be a polymer battery. The gelled electrolyte may include an electrolyte solution and a polymer material. The polymer material may form a polymer matrix. The polymer material may include at least one selected from the group consisting of PVdF, PVdF-HFP, polyacrylonitrile (PAN), PVdF-PAN, polyethylene oxide (PEO), polyethylene glycol (PEG), and derivatives of these, for example.

### EXAMPLES

### —Production of Positive Electrode Active Material—

### (a) Forming Slurry

Various positive electrode active materials were produced by the procedure described below. Lithium hydroxide monohydrate, manganese carbonate, ferric phosphate, and lithium dihydrogen phosphate were prepared in amounts that satisfied the composition ratio specified in the composition formula “Li_{1.04}Mn_{0.6}Fe_{0.4}PO₄”. Glucose was prepared in an amount of 8% in mass fraction relative to the total mass of the raw materials. The materials thus prepared and water were mixed together to form a slurry. The solid concentration of the slurry was 30% in mass fraction. Wet grinding was carried out to achieve a D50 of 0.30 μm.

### (b) Granulation

The slurry was spray dried to form secondary particles. The basic settings of the spray dryer are as follows.
Temperature at air inlet: 250° C.
Temperature at air outlet: 115±15° C.
Air intake pressure: 2.0 MPa
Nozzle pressure of spray nozzle: 0.2±0.1 MPa
Target value of D50 of secondary particles: 9±4 μm

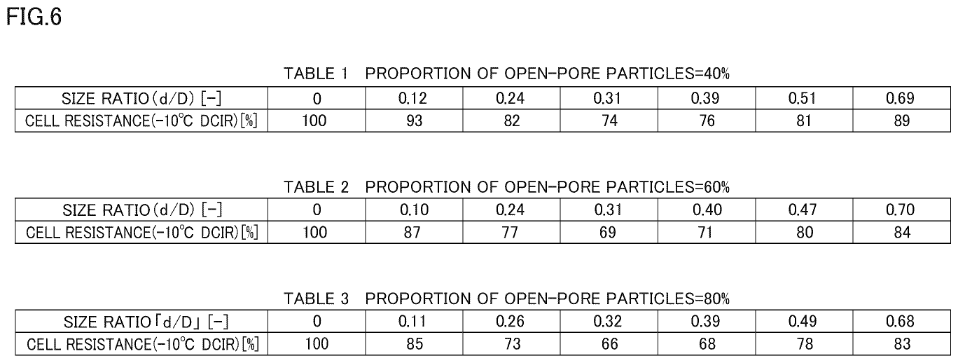

FIG. 6 is a table showing experiment results. In addition to the above-described basic settings, various other conditions were adjusted, and thereby powders specified in FIG. 6 were formed that had a proportion of open-pore particles of 40%, 60%, or 80% and that were different in size ratio “d/D”. It should be noted that the proportion of open-pore particles and the size ratio “d/D” were values after “(c) Calcination” described below, not values immediately after “(b) Granulation”.

For example, the slurry temperature was adjusted within the range of 40 to 60° C. or within the range of 50 to 60° C., to adjust the proportion of open-pore particles.

For example, in addition to the adjustment of the slurry temperature, the amount of a dispersant to be added to the slurry was also adjusted within the range of 0.3 to 1% in mass fraction, to adjust the pore diameter of the open pore.

For example, different combinations of the nozzle pressure, the slurry temperature, and the amount of the dispersant to be added were adopted to adjust the size ratio “d/D”.

### (c) Calcination

The secondary particles were calcined in a nitrogen atmosphere, and thereby LMFP was synthesized. FIG. 5 is a temperature profile during calcination. Firstly, the furnace temperature is raised at a temperature raising rate of 3° C./minute to reach 200° C. The furnace temperature is maintained at 200° C. for 1 hour. Then, the furnace temperature is raised at a temperature raising rate of 5° C./minute to reach 650° C. The furnace temperature is maintained at 650° C. for 5 hours. Subsequently, the furnace temperature is lowered at a temperature lowering rate of 2° C./minute to reach 400° C. Furthermore, the furnace temperature is lowered at a temperature lowering rate of 15° C./minute to reach room temperature.

### —Evaluation—

### Preparation of Coin Cell

The positive electrode active material, a conductive material (acetylene black) and a binder (PVdF) were mixed together to form a mixture. The mixing ratio (in mass) was “(positive electrode active material)/(conductive material)/binder=92/5/3”. The mixture was dispersed in a solvent (N-methyl-2-pyrrolidone) to form a paste. The solid concentration of the paste was 50% in mass fraction. The paste was applied to the surface of an Al foil sheet, followed by drying, and thereby a positive electrode layer was formed. The density of the positive electrode layer was adjusted to 1.8 g/cm³ with a roll press, and thereby a positive electrode raw sheet was formed. The positive electrode raw sheet was vacuum dried at 120° C. for 12 hours. After drying, the positive electrode raw sheet was die-cut to form a disk-shaped sample (diameter, 14 mm).

Inside a glove box, a coin cell was assembled. The cell configuration is as described below.
Working electrode: Disk-shaped sample (positive electrode)
Counter electrode: Li foil sheet
Separator: Porous polymer film
Electrolyte solution: “EC/DMC-3/7 (in volume)”, LiPF₆ (1 mol/L)
Low-Temperature Properties (DCIR at −10° C.)

Cell resistance (DCIR at −10° C.) was measured by the procedure described below. It is conceivable that the lower the cell resistance is, the better the low-temperature properties are.

Initial charging and discharging of the coin cell is carried out under the below conditions.
Mode: Constant current-constant voltage (CCCV) mode
Rate: 0.01 C
Lower limit voltage: 3.0 V
Upper limit voltage: 4.3 V

“C” is a symbol denoting a rate of current (an hour rate). At a rate of 1 C, the stoichiometric capacity of a coin cell is charged or discharged in 1 hour.

Then, at a rate of 0.1 C, the coin cell is charged to an SOC (State Of Charge) of 60%. In a thermostatic chamber set at −10° C., the coin cell is discharged at a rate of 1 C. After a lapse of 10 seconds from the start of discharging, the voltage is measured. In the same manner, the voltage is measured at a rate of 2 C, 3 C, 4 C, and 5 C, respectively. The results of the measurement are plotted on a two-dimensional coordinates with the horizontal axis representing the electric current and the vertical axis representing the voltage, and the absolute value of the slope of the straight line thus obtained is regarded as the cell resistance (DCIR at −10° C.).

### —Results—

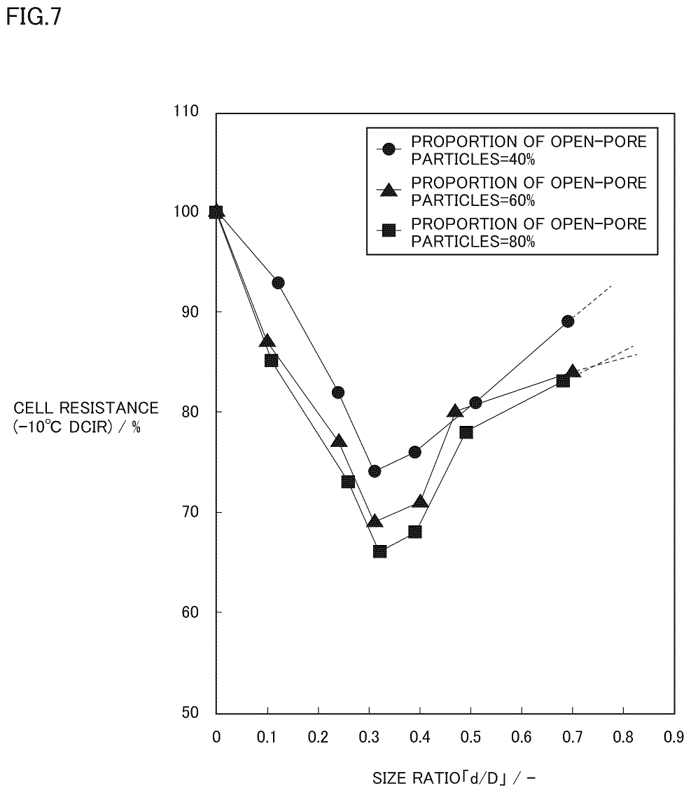

FIG. 7 is a graph showing experiment results. FIG. 7 is created by plotting the data shown in FIG. 6. As seen in FIG. 7, depending on the size ratio “d/D”, the cell resistance hits the lowest value. As the open pores become larger, the liquid retention properties of the secondary particles become enhanced. On the other hand, as the open pores become larger, the secondary particles become brittle; there is a possibility that the open pores can become crushed at the time when the electrode is pressed and thereby the open pores may not be maintained in the electrode.

Referring to FIG. 6 and FIG. 7, when the proportion of open-pore particles is 40% or more and the relationship of “0.1≤d/D≤0.70” is satisfied, low-temperature properties tend to be enhanced.

Referring to FIG. 6 and FIG. 7, when the relationship of “0.24≤d/D≤0.51” is satisfied, low-temperature properties tend to be enhanced.

Referring to FIG. 6 and FIG. 7, when the relationship of “0.31≤d/D≤0.40” is satisfied, low-temperature properties tend to be enhanced.

Referring to FIG. 6 and FIG. 7, when the proportion of open-pore particles is 60% or more, low-temperature properties tend to be enhanced.

Referring to FIG. 6 and FIG. 7, when the proportion of open-pore particles is 80% or more, low-temperature properties tend to be enhanced.

What is claimed is:

1. A positive electrode active material comprising:
powder, wherein
the powder includes secondary particles,
each of the secondary particles includes primary particles,
each of the primary particles includes an olivine-type phosphate compound,
in a scanning electron microscope image of the powder, a proportion of the secondary particles each having an open pore is 40% or more, and
for the secondary particles each having an open pore, a relationship of:
$$0. 10 \leq d / D \leq 0.7$$
is satisfied, where
d represents a pore diameter of the open pore, and
D represents a maximum Feret diameter of the secondary particle.

2. The positive electrode active material according to claim 1, wherein for the secondary particles each having an open pore, a relationship of:
$$0.24 \leq d / D \leq 0.51$$
is satisfied.

3. The positive electrode active material according to claim 2, wherein for the secondary particles each having an open pore, a relationship of:
$$0.31 \leq d / D \leq 0.4$$
is satisfied.

4. The positive electrode active material according to claim 1, wherein the proportion of the secondary particles each having an open pore is 60% or more.

5. The positive electrode active material according to claim 1, wherein the proportion of the secondary particles each having an open pore is 80% or more.

6. The positive electrode active material according to claim 1, wherein a maximum Feret diameter of the primary particle is from 10 to 90 nm.

7. The positive electrode active material according to claim 1, wherein the olivine-type phosphate compound includes lithium manganese phosphate.

8. An electrode comprising:
a positive electrode layer, wherein
the positive electrode layer includes the positive electrode active material according to claim 1.

9. A battery comprising:
the electrode according to claim 8; and
an electrolyte solution.

10. The battery according to claim 9, having a bipolar structure.
